(19) United States
(12) Patent Application Publication
(10) Pub. No.: US 2008/0090938 A1
(43) Pub. Date: Apr. 17, 2008

(54) Fouling Resistant Polyurethanes, in Particular for Maritime Use

(75) Inventors: Stefan Quaiser, Damme (DE); Ian Lynam, Ripley Derbyshire (GB); Michael Wind, Kalletal (DE); Alex Celik, Wymeswoid (GB); Gunnar Kampf, Stemwede-Haldem (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/908,039

(22) PCT Filed: Mar. 8, 2006
(86) PCT No.: PCT/EP06/60570

§ 371 Date: Sep. 7, 2007

(30) Foreign Application Priority Data
Mar. 14, 2005 (DE) 10 2005 011 990.5

(51) Int. Cl. C08G 18/00

(52) U.S. Cl. 523/122

(57) ABSTRACT

The invention relates to polyurethanes which comprise biocides, a process for their preparation and the use thereof for the production of maritime articles which have anti-fouling activity.

The invention relates to polyurethanes which comprise biocides, a process for their preparation and the use thereof for the production of maritime articles which have antifouling activity.

Polyurethanes have long been used for the production of products which are used in maritime regions. Since some of these products are used below the water surface, the polyurethanes must be protected from becoming overgrown with hard animal growths or soft vegetable growths. This undesired overgrowth is referred to among those skilled in the art as “fouling”. Without such protection, fouling of the polymers occurs, which may lead to destruction of the product produced from the polymeric material, such as, for example, buoys, floats and offshore pipes.

One method for protecting the polymeric material from animal and vegetable fouling is the addition of the biocide tributyltin (TBT), which however is toxicologically unsafe. Thus, the use of TBT is already prohibited throughout the EU.

For ecotoxicological and legal reasons, a tin-free method for protection against fouling of the materials is therefore necessary. This protection is produced today generally by so-called silicone foul-release coatings, which, however, is a very complicated technique since the surface of the polymeric material has to be cleaned by a complicated procedure before application of the silicone foul-release coating and the products exposed in the waters have to be cleaned at very short intervals by a complicated procedure to remove the fouling. A further disadvantage of the use of silicone foul-release coatings is the low abrasion resistance thereof, with the result that the surface of the silicone foul-release coating may be damaged on exposure of the products, and fouling is thus promoted.

It was therefore an object of the present invention to provide polyurethanes which firstly are effectively protected from fouling without the use of tin compounds, secondly do not have the disadvantages described above (for example complicated cleaning) and thirdly do not exhibit an adverse influence on the characteristic mechanical properties of the polymeric material by the use of a biocide.

The object could be achieved by the use of the chemical biocides which are described in more detail below and are added either as the sole additive or as a component of a mixture to the polyurethane.

The invention therefore relates to a polyurethane obtainable by reacting

a) polyisocyanates with a

b) polyol component comprising polyesterpolyols and/or polyetherpolyols in the presence of a

c) biocide selected from
3-benzo[b]thien-2-yl-5,6-dihydro-1,4,2-oxathiazine 4-oxide (i),
2-(thiocyanomethylthio)benzothiazole (ii),
2-p-(chlorophenyl)-3-cyano-4-bromo-5-trifluoromethylpyrrole (iii),
tetrahydro-N-(trichloromethylthio)phthalimide (iv),
bis(1-hydroxy-1H-pyridine-2-thionato-O,S)copper (v) and
bis(1-hydroxy-1H-pyridine-2-thionato-O,S)zinc (vi),
or mixtures thereof.

The polyurethanes according to the invention are preferably fouling-resistant. In the context of the invention, a fouling-resistant polymer is understood as meaning a polymer which has a fouling rating of greater than or equal to 40 after storage for 6 months from May to November in the North Sea according to ASTM method 6990-03 2004. The fouling rating of ASTM standard 6990-03 2004 is defined here as the area of the polymer, in percent, which exhibits no contamination by fouling.

The polyurethanes according to the invention are obtainable by reacting polyisocyanates (a) with a polyol component (b) which comprises polyetherpolyols, in the presence of a biocide (c).

For components (a) and (b), the following is applicable:

the polyisocyanates a) used comprise the conventional aliphatic, cycloaliphatic and in particular aromatic di- and/or polyisocyanates. Toluene diisocyanate (TDI), diphenyl-methane diisocyanate (MDI) and mixtures of diphenylmethane diisocyanate and polyphenylenepolymethylene polyisocyanates (crude MDI) are preferably used, in particular diphenylmethane diisocyanate (MDI). The isocyanates may also be modified, for example by incorporation of urea, uretdione, carbamate, isocyanurate, carbodiimide, allophanate and urethane groups. In particular, the isocyanates are modified with urethane groups, i.e. they are present in the form of polyurethane prepolymers. These prepolymers are obtainable by reacting isocyanates with OH-functional compounds. Furthermore, mixtures of the various isocyanates may be used.

The polyol component (b) comprises polyesterpolyols and/or polyetherpolyols, preferably polyetherpolyols. The preferred polyetherpolyols are prepared by processes known from the literature, for example by anionic polymerization using alkali metal hydroxides or alkali metal alcoholates as catalysts, or with the aid of double metal cyanide catalysts and with addition of at least one initiator molecule which comprises bound reactive hydrogen atoms, from one or more alkylene oxides having 2 to 4 carbon atoms in the alkylene radical. Suitable alkylene oxides are, for example, tetrahydrofuran, ethylene oxide and 1,2-propylene oxide. The alkylene oxides may be used individually, alternately in succession or as mixtures.

Mixtures of 1,2-propylene oxide and ethylene oxide are preferred, in particular the ethylene oxide being used as a terminal ethylene oxide block (“EO-cap”). In a further particularly preferred embodiment, only 1,2-propylene oxide is used as the alkylene oxide.

In preferred embodiments, the polyol component (b) comprises one or more components selected from the components (b-1), (b-2), (b-3) and (b-4) described below. The polyol side includes the component (b-1), and the components (b-2), (b-3) and (b-4) are optional and, if appropriate, are present in the polyol component (b).

Polyetherpolyols which are obtainable by alkoxylation of a difunctional and/or trifunctional alcohol can preferably be used in this invention. The polyetherpolyols obtained thereby are referred to as component (b-1) in the context of this invention.

For example, ethanediol, 1,2- and 1,3-propanediol, diethylene glycol, ethylene glycol, dipropylene glycol, propylene glycol, 1,4-butanediol or 1,6-hexanediol or mixtures thereof can be used as difunctional initiator molecules for the preparation of polyetherols.

In general, the alkoxylation of the difunctional initiators is carried out in such a way that the polyetherol has a number-average molecular weight of from 400 g/mol to 8000 g/mol, preferably from 600 to 7000 g/mol, particularly preferably from 800 to 6000 g/mol and in particular from 900 to 5000 g/mol.

Glycerol, trimethylolpropane or mixtures thereof are preferably used as trifunctional initiator molecules for the preparation of polyetherols.

In general, the alkoxylation of the trifunctional initiator molecules is carried out in such a way that the polyetherol has a number-average molecular weight of from 400 g/mol to 12 000 g/mol, preferably from 1000 to 9000 g/mol, particularly preferably from 1800 to 8000 g/mol and in particular from 2500 to 7000 g/mol

It is also possible for a mixture of difunctional and trifunctional initiators to be alkoxylated.

The polyol component (b) may furthermore comprise a chain extender as optional component (b-2). In general, chain extenders are understood as meaning branched or straight-chain alcohols or amines, preferably dihydric alcohols, having a molecular weight of less than 400 g/mol, preferably less than 300 g/mol, in particular from 60 to 250 g/mol. Examples of these are ethylene glycol, 1,6-hexanediol, 1,5-pentanediol, 1,4-butanediol, 1,3-propanediol, diethylene glycol or dipropylene glycol.

If appropriate, the polyol component may comprise a polyetherpolyol based on a tetrafunctional or higher-functional initiator molecule as optional component (b-3). The use of tetrafunctional to hexafunctional initiator molecules is preferred.

Examples of suitable initiator molecules are pentaerythritol, sorbitol and sucrose.

In general, the alkoxylation of the tetrafunctional to hexafunctional initiator molecules is carried out in such a way that the resultant polyetherpolyol has a number-average molecular weight of from 200 g/mol to 12 000 g/mol, preferably from 4000 to 9000 g/mol, particularly preferably from 500 to 5000 g/mol and in particular from 600 to 4000 g/mol.

If appropriate, the polyol component may comprise, as additional component (b-4), an oil based on fatty acids having 6 to 25 carbon atoms, preferably 10 to 24 carbon atoms, particularly preferably 12 to 22 carbon atoms, or derivatives thereof. The oils known from the prior art and based on fatty acids having 6 to 25 carbon atoms may be used as (b-4), provided that they are compatible with the polyurethane system components.

The oil preferably comprises triglycerides of fatty acids having 6 to 25 carbon atoms or derivatives thereof. Particularly preferably, the oil also comprises free glycerol in addition to the triglycerides of fatty acids having 6 to 25 carbon atoms. In general, the free glycerol content is from 0.1 to 20% by weight, preferably from 5 to 15% by weight, in particular from 7 to 12% by weight, based on the total weight of the oil.

Examples of suitable acids are caproic acid, caprylic acid, capric acid, lauric acid, myristic acid, palmitic acid, stearic acid, arachidic acid, behenic acid, lignoceric acid, lauroleic acid, myristoleic acid, palmitoleic acid, oleic acid, gadoleic acid, erucic acid, ricinoleic acid, linoleic acid and linolenic acid. The acids can be used individually or as a mixture. Palmitic acid, stearic acid, oleic acid, ricinoleic acid, linoleic acid and linolenic acid are preferably used. Ricinoleic acid is particularly preferably used.

The oils to be used may be synthetic or natural oils. Castor oil is particularly preferably used as optional component (b-4).

The oils (b-4) can be used as such in the form of derivatives. Here, derivatives are understood as meaning the substances which are known from the prior art and are obtainable by modification of the oils. Examples of modification are transformations at the double bonds, for example by thermal polymerization, isomerization, dehydration or addition or substitution of the double bonds, such as, for example, an epoxidation of the CC double bond with subsequent epoxide ring opening and alkoxylation of the OH group thus prepared, or transformation of the glyceride system, for example transesterification.

Ricine oil, which is obtainable by dehydration of castor oil, is a preferably used derivative and is employed as optional component (b-4).

If appropriate, additives may also be added to the polyol component. Catalysts (compounds which accelerate the reaction of the isocyanate component with the polyol component), surface-active substances, antifoams, deaerators, leveling agents, dyes, pigments, hydrolysis stabilizers, antioxidants, plasticizers and UV stabilizer may be mentioned by way of example here.

Furthermore, the polyol component may comprise thixotropic additives, such as, for example, Laromin® C 260 (dimethylmethylenebiscyclohexylamine). In general, the amount of these additives which is used is between 0.1 and 3 parts by weight, based on 100 parts by weight of the polyol component.

It is furthermore possible to add the blowing agents known from the prior art to the polyol component b). However, it is preferable if the isocyanate component and the polyol component comprise no physical and no chemical blowing agent. It is furthermore preferable if no water is added to these components. Thus, the components a) and b) particularly preferably comprise no blowing agent apart from residual water which is present in industrially produced polyols.

It is furthermore particularly preferable if the residual water content is reduced by adding water scavengers. Suitable water scavengers are, for example, zeolites. The water scavengers are used, for example, in an amount of from 0.1 to 10% by weight,

based on the total weight of the polyol component b).

In a first preferred embodiment, the polyol component (b) comprises the following amounts of the components (b-1) to (b-4):

from 50 to 100% by weight, preferably from 85 to 95% by weight, of (b-1),

from 0 to 30% by weight, preferably from 5 to 15% by weight, of (b-2),

from 0 to 20% by weight, preferably 0% by weight, of (b-3) and

from 0 to 20% by weight, preferably 0% by weight, of (b-4),

based on the total weight of the components (b-1) to (b-4).

In this embodiment, the polyol components described are preferably reacted with 4,4′-MDI or a prepolymer based on 4,4′-MDI. Elastomeric polyurethanes, in particular cold-cast polyurethane elastomers, are preferably obtainable thereby.

The polyurethanes obtained in this first embodiment generally have a density from 0.8 kg/l to 1.3 kg/l, preferably from 0.9 kg/l to 1.1 kg/l.

The polyurethanes obtained by this first preferred embodiment are preferably used for coating offshore pipes and floats, such as, for example, buoys.

In a second preferred embodiment, the polyol component (b) comprises the following amounts of the components (b-1) to (b-4):

from 10 to 100% by weight, preferably from 30 to 80% by weight, of (b-1),

from 0 to 30% by weight, preferably from 0 to 10% by weight, of (b-2),

from 0 to 20% by weight, preferably from 1 to 5% by weight, of (b-3) and

from 0 to 80% by weight, preferably from 20 to 50% by weight, of (b-4), based on the total weight of the components (b-1) to (b-4).

In this embodiment, the polyol components described are preferably reacted with an above-described mixture of diphenylmethane diisocyanate and polyphenylene-polymethylene polyisocyanates.

This second preferred embodiment is preferably reacted in the presence of the hollow microspheres described below (components (d)). So-called “syntactic polyurethanes” are obtainable thereby. These syntactic polyurethanes generally have a density of from 0.3 kg/l to 0.9 kg/l, preferably from 0.5 kg/l to 0.8 kg/l.

The polyurethanes obtained by this second preferred embodiment are preferably used for the production, in particular for the insulation, of offshore pipes, sockets and pipe manifolds.

The polyurethanes according to the invention are obtainable by reacting the components (a) and (b) in the presence of a biocide or of a plurality of biocides, selected from the biocides (i) to (vi).

Regarding the biocides (i) to (vi), the following may be stated:

In an embodiment of the invention, the polymer according to the invention comprises 3-benzo[b]thien-2-yl-5,6-dihydro-1,4,2-oxathiazine 4-oxide (i). 3-Benzo[b]thien-2-yl-5,6-dihydro-1,4,2-oxathiazine 4-oxide (i) is described by the following structural formula:

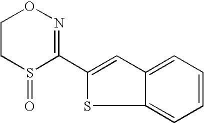

In a further preferred embodiment, the polymer according to the invention comprises 2-(thiocyanomethylthio)benzothiazole (ii), which is described by the following structural formula:

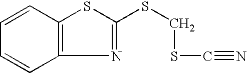

In a further embodiment, the polymer according to the invention comprises 2-p-(chlorophenyl)-3-cyano-4-bromo-5-trifluoromethylpyrrole (iii), which is described by the following structural formula:

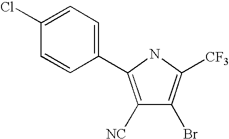

In a further embodiment, the polymer according to the invention comprises tetrahydro-N-(trichloromethylthio) phthalimide (iv), which is described by the following structural formula:

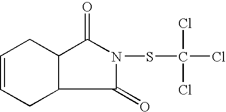

In a further embodiment, the polymer according to the invention comprises bis(1-hydroxy-1H-pyridine-2-thionato-O,S) copper (v), which is described by the following structural formula:

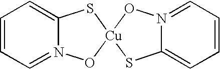

In a further embodiment, the polymer according to the invention comprises bis(1-hydroxy-1H-pyridine-2-thionato-O,S)zinc (vi), which is described by the following structural formula:

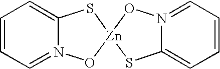

In a preferred embodiment, the component (c) is selected from:

3-benzo[b]thien-2-yl-5,6-dihydro-1,4,2-oxathiazine 4-oxide,

2-(thiocyanomethylthio)benzothiazole,

2-p-(chlorophenyl)-3-cyano-4-bromo-5-trifluoromethylpyrrole,

tetrahydro-N-(trichloromethylthio)phthalimide,

bis(1-hydroxy-1H-pyridine-2-thionato-O,S)copper,

bis(1-hydroxy-1H-pyridine-2-thionato-O,S)zinc or mixtures thereof.

In a more preferred embodiment, the component (c) is selected from:

3-benzo[b]thien-2-yl-5,6-dihydro-1,4,2-oxathiazine 4-oxide,

2-(thiocyanomethylthio)benzothiazole,

2-p-(chlorophenyl)-3-cyano-4-bromo-5-trifluoromethylpyrrole,

tetrahydro-N-(trichloromethylthio)phthalimide,

bis(1-hydroxy-1H-pyridine-2-thionato-O,S)copper or mixtures thereof.

In a particularly preferred embodiment, the component (c) is selected from:

3-benzo[b]thien-2-yl-5,6-dihydro-1,4,2-oxathiazine 4-oxide,

2-(thiocyanomethylthio)benzothiazole,

2-p-(chlorophenyl)-3-cyano-4-bromo-5-trifluoromethylpyrrole or mixtures thereof.

In particular, the component (c) is selected from:

3-benzo[b]thien-2-yl-5,6-dihydro-1,4,2-oxathiazine 4-oxide, and

2-(thiocyanomethylthio)benzothiazole or mixtures thereof.

The amount of biocide (c) used is in general from 0.1 to 20 percent by weight, preferably 0.2 to 10 percent, more preferably from 0.3 to 7 percent, even more preferably from 0.4 to 6 percent, particularly preferably from 0.5 to 5 percent and in particular from 0.6 to 3.5 percent, based on the total weight of the polyurethane.

Furthermore, the hollow microspheres (d) may be added to the reaction mixture comprising the components (a) and (b) and (c). The term hollow microspheres is to be understood as meaning organic and mineral hollow spheres. Organic hollow spheres which may be used are, for example, hollow plastic spheres, for example comprising polyethylene, polypropylene, polyurethane, polystyrene or a blend thereof. The mineral hollow spheres may comprise, for example, clay, aluminum silicate, glass or mixtures thereof.

The hollow spheres may have a vacuum or partial vacuum in the interior or be filled with air, inert gases, for example nitrogen, helium or argon, or reactive gases, for example, oxygen.

Usually, the organic or mineral hollow spheres have a diameter of from 1 to 1000 μm, preferably from 5 to 200 μm. Usually, the organic or mineral hollow spheres have a bulk density of from 0.1 to 0.4 g/cm³. They generally have a thermal conductivity of from 0.03 to 0.12 W/mK.

Hollow glass microspheres are preferably used as hollow microspheres. In a particularly preferred embodiment, the hollow glass microspheres have a hydrostatic compressive strength of at least 20 bar. For example, 3M - Scotchlite® Glass Bubbles may be used as hollow glass microspheres.

The hollow microspheres are generally added in an amount of from 1 to 80% by weight, preferably from 2 to 50, more preferably from 5 to 35,% by weight and particularly preferably from 10 to 30% by weight, based on the total weight of the resulting polyurethane.

The invention furthermore relates to a process for the preparation of a polyurethane by reacting

a) polyisocyanates with

b) a polyol component comprising polyetherpolyols, in the presence of a biocide (c) selected from
3-benzo[b]thien-2-yl-5,6-dihydro-1,4,2-oxathiazine 4-oxide (i),
2-(thiocyanomethylthio)benzothiazole (ii),
2-p-(chlorophenyl)-3-cyano-4-bromo-5-trifluoromethylpyrrole (iii),
tetrahydro-N-(trichloromethylthio)phthalimide (iv),
bis(1-hydroxy-1H-pyridine-2-thionato-O,S)copper (v) and
bis(1-hydroxy-1H-pyridine-2-thionato-O,S)zinc (vi),
   or mixtures thereof.

For the components a) to c) used, reference is made here to the above statements. This also applies to the additives described above.

For the preparation of the polyurethanes, the polyisocyanates a) polyol component and b) are reacted in amounts such that the ratio of the number of equivalents of NCO groups of the polyisocyanate a) to the sum of the reactive hydrogen atoms of component b) is from 1:0.5 to 1:3.50 (corresponding to an isocyanate index of from 50 to 350), preferably from 1:0.85 to 1:1.30 and particularly preferably from 1:0.9 to 1:1.15.

The starting components are usually mixed at a temperature of from 0° C. to 100° C., preferably from 15 to 60° C., and reacted. The mixing can be effected using the conventional PU processing machines. In a preferred embodiment the mixing is effected by low pressure machines or high pressure machines.

The biocide (c) can be introduced by prior mixing of (c) with the component (a) and/or (b). Likewise, (c) can be added to the reacting reaction mixture comprising (a) and (b). Preferably, (c) is first mixed with the polyol component (b), and the mixture of (b) and (c) is then reacted with (a).

The optional incorporation of the hollow microspheres d) into the PU component is effected by methods known from the prior art. It is possible to add the hollow microspheres before the reaction to at least one of the components a) or b) and/or to add the hollow microspheres to the still reacting reaction mixture immediately after reaction of the components a) and b). Examples of suitable methods of mixing are described in WO 94/20286, WO 02/102887 and WO 02/072701. The mixing pot method according to WO 02/102887 is preferably employed.

The invention furthermore relates to the use of a biocide (c) selected from

3-benzo[b]thien-2-yl-5,6-dihydro-1,4,2-oxathiazine 4-oxide (i),

2-(thiocyanomethylthio)benzothiazole (ii),

2-p-(chlorophenyl)-3-cyano-4-bromo-5-trifluoromethylpyrrole (iii),

tetrahydro-N-(trichloromethylthio)phthalimide (iv),

bis(1-hydroxy-1H-pyridine-2-thionato-O,S)copper (v) and

bis(1-hydroxy-1H-pyridine-2-thionato-O,S)zinc (vi), or mixtures thereof.

for the preparation of fouling-resistant polymers, in particular for the preparation of fouling-resistant polyurethanes.

The invention furthermore relates to the use of a biocide (c) for the preparation of fouling-resistant polyurethanes which are used for the production of maritime articles.

Maritime articles are to be understood as meaning articles which, when used for the intended purpose, are constantly in contact with sea water. Examples of maritime articles are offshore pipes, sockets, pipe manifolds, pumps and floats, such as, for example, buoys.

In the context of this invention, offshore pipe is understood as meaning a pipe which serves for transporting oil and gas. The oil/gas generally flows therein from the bottom of the sea to platforms, into ships/tankers or directly onto land.

Sockets are to be understood as the connections of two pipes or pipe sections.

The invention therefore relates to a maritime article comprising the polyurethanes according to the invention.

The invention relates in particular to an offshore pipe composed of

(i) an inner pipe and, adhesively mounted thereon,

(ii) a layer of polyurethane according to the invention.

An alternative embodiment of the offshore pipe according to the invention comprises

(i) an inner pipe, preferably a metal pipe, mounted thereon,

(ii) a layer of insulating material, preferably foam, and, mounted thereon,

(iii) a layer of polyurethane according to the invention, preferably a coating layer comprising compact polyurethane according to the invention.

The invention also relates to a buoy coated with polyurethane according to the invention.

The invention is to be illustrated by the following examples.

### Examples

The following components were used in the examples:

| | |
|---|---|
| Elastomer | Elasturan ® 6006/105/A80 (manufacturer: Elastogran GmbH) |
| system: | |
| Biocide 1: | Tributyltin oxide (TBT) |
| Biocide 2: | 3-Benzo[b]thien-2yl-5,6-dihydro-1,4,2-oxathiazine 4-oxide |
| Biocide 3: | 2-p-(Chlorophenyl)-3-cyano-4-bromo-5-trifluoromethylpyrrole |
| Biocide 4: | 2-(Thiocyanomethylthio)benzothiazole |
| Biocide 5: | Tetrahydro-N-(trichloromethylthio)phthalimide |
| Biocide 6: | Bis(1-hydroxy-1H-pyridine-2-thionato-O,S)copper |
| Biocide 7: | Bis(1-hydroxy-1H-pyridine-2-thionato-O,S)zinc |

Round Petri dishes coated with polyurethane elastomers and having a diameter of 9 cm were produced from the stated polyurethane system with addition of the biocides. These were covered with a layer of sea water, about 50 barnacle larvae were added and incubation was effected for a period of from 5 to 7 days at a temperature of 27±2° C. and under defined light conditions (light incident for 15 h and darkness for 9 h per day). After the incubation, the number of barnacle larvae which had colonized the polymeric material is determined with the aid of a microscope. The percentage ratio of the barnacle larvae colony to the number of larvae added to the system is described in table 1 as colonization %.

Polyurethane elastomers were prepared from the stated polyurethane system with addition of the biocidal compounds or the addition of biocide mixtures, and test sheets of 10 cm*10 cm edge length were produced from these. The test sheets thus produced were exposed a few centimeters below water surface in the harbor based at Nordeney in the North Sea in the period from May to November 2004, and the fouling of the sheets was determined on the basis of ASTM method 6990-03 2004. Here, the percentage of unfouled area of the test sheets is determined and is mentioned as the “fouling rating” in the table below. In addition, the dry weight of the fouling on the test sheets was determined gravimetrically. For this purpose, the fouling is scratched off the test sheet, dried at 60° C. and weighed. The parameter stated below as “fouling weight” is the mass of the fouling, based on the area of the test sheet. Quantification of the animal fouling of the test sheets was furthermore effected by determining the percentage of the area of the test sheets which was covered by animal hard fouling; in the table, the percentage of the region not covered by animal hard fouling is designated as the hard fouling rating.

In addition, the Shore A hardness according to DIN 53505, the tensile strength and the stress at 100% and 300% strain according to the ASTM D412 and tear propagation resistance according to ASTM D624 were determined. These data are summarized in Table 3.

In the table below, the concentration of the biocides used is stated in each case in percent by mass, based on the total weight of the polyurethane elastomer.

TABLE 1
Determination of the percentage ratio of the barnacle larvae colony to
the number of larvae added to the system (colonization %), according
to the colonization test described.
Examples 1 and 2 are comparative examples.

| | Ex. 1 | Ex. 2 | Ex. 3 | Ex. 4 | Ex. 5 | Ex. 6 | Ex. 7 | Ex. 8 |
|---|---|---|---|---|---|---|---|---|
| biocide 1 | | 0.07 | | | | | | |
| biocide 2 | | | 0.07 | 0.035 | | | | |
| biocide 3 | | | | 0.035 | | | | |
| biocide 4 | | | | | 0.07 | | | |
| biocide 5 | | | | | | 0.07 | | |
| biocide 6 | | | | | | | 0.07 | |
| biocide 7 | | | | | | | | 0.07 |
| Colonization % | 85.1 | 2.3 | 0.0 | 0.0 | 0.0 | 12.7 | 0.0 | 4.6 |

TABLE 2
Evaluation of the fouling on test sheets which were exposed
briefly under the water surface in the North Sea in the period from
May to November 2004. The fouling rating as well as the hard
fouling rating and the fouling weight had been determined as
described above. Examples 9 and 10 are comparative examples.

| | | Example | Example | Example | Example |
|---|---|---|---|---|---|
| | Example 9 | 10 | 11 | 12 | 13 |
| biocide 1 | | 0.7 | | | |
| biocide 2 | | | 0.7 | | |
| biocide 3 | | | 0.7 | | |
| biocide 4 | | | | 0.7 | |
| biocide 5 | | | | | 0.7 |
| Fouling | 34 | 99 | 90 | 94 | 70 |
| rating after | | | | | |
| 5 months | | | | | |
| Fouling | 1 | 99 | 87 | 59 | 42 |
| rating after | | | | | |
| 6 months | | | | | |
| Hard fouling | 12 | 99 | 88 | 89 | 46 |
| rating after | | | | | |
| 6 months | | | | | |
| Fouling | 60.83 | 2.14 | 16.34 | 11.83 | 28.49 |
| weight [g] | | | | | |
| after | | | | | |
| 6 months | | | | | |

The efficiency of the biocides according to the invention is evident from tables 1 and 2.

TABLE 3
Comparison of the Shore A hardness according to DIN 53505, of the
tensile strength and of the stress at 100% and 300% strain according
to ASTM D412 and of the tear propagation resistance according
to ASTM D624.
Examples 14 and 15 are comparative examples.

| | Ex. 14 | Ex. 15 | Ex. 16 | Ex. 17 | Ex. 18 | Ex. 19 | Ex. 20 | Ex. 21 |
|---|---|---|---|---|---|---|---|---|
| biocide 1 | | 0.7 | | | | | | |
| biocide 2 | | | 0.7 | 0.35 | | | | |
| biocide 3 | | | | 0.35 | | | | |
| biocide 4 | | | | | 0.7 | | | |
| biocide 5 | | | | | | 0.7 | | |
| biocide 6 | | | | | | | 0.7 | |
| biocide 7 | | | | | | | | 0.7 |
| Shore A | 76 | 73 | 75 | 75 | 72 | 72 | 76 | 75 |
| hardness | | | | | | | | |
| Tensile | 9 | 9 | 8 | 8 | 8 | 8 | 8 | 8 |
| strength | | | | | | | | |
| [MPa] | | | | | | | | |
| Stress at | 4.2 | 4.4 | 4.1 | 4.5 | 4.1 | 4.1 | 4.2 | 4.2 |
| 100% strain | | | | | | | | |
| [MPa] | | | | | | | | |
| Stress at | 7.5 | 7.6 | 7.2 | 7.8 | 7.3 | 7.3 | 7.2 | 7.6 |
| 300% strain | | | | | | | | |
| [MPa] | | | | | | | | |
| Tear | 52 | 50 | 50 | 70 | 47 | 49 | 48 | 48 |
| propagation | | | | | | | | |
| resistance | | | | | | | | |
| [N/mm] | | | | | | | | |

It is evident that the mechanical data are influenced only insignificantly by the addition of the biocides.

1-10. (canceled)

11: A polyurethane obtainable by reacting a) polyisocyanates with b) a polyol component comprising polyesterpolyols and/or polyetherpolyols, in the presence of a biocide (c) comprising 2-(thiocyanomethylthio)benzothiazole.

12: The polyurethane according to claim 1, wherein the biocide (c) is used in an amount of from 0.1 to 20 percent by weight, based on the total weight of the polyurethane.

13: The polyurethane according to claim 1, wherein the biocide (c) is used in an amount of from 0.6 to 3.5 percent by weight, based on the total weight of the polyurethane.

14: The polyurethane according to claim 1, wherein the polyetherpolyols are obtainable by alkoxylation of a di- or trifunctional alcohol.

15: The polyurethane according to claim 1, which is a cold-cast polyurethane elastomer.

16: The polyurethane according to claim 1, wherein the polyurethane comprises hollow microspheres (d).

17: A process for the preparation of a polyurethane by reacting a) polyisocyanates with b) a polyol component comprising polyetherpolyols, in the presence of a biocide (c) comprising 2-(thiocyanomethylthio)benzothiazole.

18: A maritime article comprising a polyurethane according to claim 1.

19: The article according to claim 8, which is an offshore pipe, socket, pipe manifold, pump and/or float.
